(19) United States
(12) Patent Application Publication
(10) Pub. No.: US 2025/0024847 A1
(43) Pub. Date: Jan. 23, 2025

(54) COATING COMPOSITIONS INCLUDING FATTY ALCOHOLS

(71) Applicant: Apeel Technology, Inc., Goleta, CA (US)

(72) Inventors: Daniel Essert, Goleta, CA (US); David Fisher, Goleta, CA (US); Justin Ryan, Goleta, CA (US)

(21) Appl. No.: 18/770,984

(22) Filed: Jul. 12, 2024

Related U.S. Application Data
(60) Provisional application No. 63/526,310, filed on Jul. 12, 2023.

(51) Int. Cl. A23B 7/16; A23B 7/154; A23L 3/3517; C08L 91/00

(52) U.S. Cl. CPC A23B 7/16; A23B 7/154; A23L 3/3517; C08L 91/00; C08L 2201/14

(57) ABSTRACT

The present disclosure relates to coatings for agricultural products including one or more monoglycerides of a C₄-C₂₈ fatty acid and one or more C₈-C₂₄ fatty alcohols. An exemplary embodiment includes about 30 wt % to about 98 wt % of one or more monoglycerides of a C₄-C₂₈ fatty acid and about 1 wt % to about 50 wt % of one or more C₈-C₂₄ fatty alcohols.

### CROSS-REFERENCE TO RELATED APPLICATION

This application claims the benefit of U.S. Patent Application No. 63/526,310 filed on Jul. 12, 2023, which is incorporated herein by reference in its entirety.

### TECHNICAL FIELD

The present disclosure relates to coatings for agricultural products.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment. The degradation of the agricultural products can occur via abiotic means as a result of evaporative moisture loss from an external surface of the agricultural products to the atmosphere and/or oxidation by oxygen that diffuses into the agricultural products from the environment and/or mechanical damage to the surface and/or light-induced degradation (i.e., photodegradation). Furthermore, biotic stressors such as, for example, bacteria, fungi, viruses, and/or pests can also infest and decompose the agricultural products.

Conventional approaches to preventing degradation, maintaining quality, and increasing the life of agricultural products include refrigeration and/or special packaging. Refrigeration requires capital-intensive equipment, demands constant energy expenditure, can cause damage or quality loss to the product if not carefully controlled, must be actively managed, and its benefits are lost upon interruption of a temperature-controlled supply chain. Special packaging can also require expensive equipment, consume packaging material, increase transportation costs, and require active management. Despite the benefits that can be afforded by refrigeration and special packaging, the handling and transportation of the agricultural products can cause surface abrasion or bruising that is aesthetically displeasing to the consumer and serves as points of ingress for bacteria and fungi. Moreover, the expenses associated with such approaches can add to the cost of the agricultural product.

### SUMMARY

Provided herein is a composition including one or more monoglycerides of a C₄-C₂₈ fatty acid, present in a total amount of about 30 wt % to about 98 wt % of the composition; and one or more C₈-C₂₄ fatty alcohols, present in a total amount of about 1 wt % to about 50 wt % of the composition.

Also provided herein is one or more monoglycerides of a C₄-C₂₈ fatty acid; and one or more C₈-C₂₄ fatty alcohols; wherein a ratio of a total number of moles of the one or more monoglycerides to a total number of moles of the one or more fatty alcohols is about 40:1 to about 1:1.

Also provided herein is a mixture of a composition described herein and a solvent.

Also provided herein is a coated agricultural product including a layer disposed on a surface of an agricultural product, the layer including a composition described herein.

Also provided herein is a method of coating an agricultural product, the method including contacting a surface of the agricultural product with a mixture including a coating agent and a solvent, and removing at least a portion of the solvent to form a coating on the surface of the agricultural product. The coating agent comprises one or more monoglycerides of a C₄-C₂₈ fatty acid; and one or more C₈-C₂₄ fatty alcohols. A ratio of a total number of moles of the one or more monoglycerides to a total number of moles of the one or fatty alcohols is about 40:1 to about 1:1.

Also provided herein is a method of coating an agricultural product, the method including contacting a surface of the agricultural product with a mixture described herein, and removing at least a portion of the solvent to form a coating on the surface of the agricultural product.

### DETAILED DESCRIPTION

The present disclosure relates to compositions including one or more monoglycerides of a C₄-C₂₈ fatty acid and one or more C₈-C₂₄ fatty alcohols. In particular, the compositions described herein can be coated onto an agricultural product to provide an improved barrier (e.g., to gas or water). Such coatings can better limit mass loss and/or CO₂ production from an agricultural product as compared to those lacking a coating. Moreover, solvent mixtures of the compositions described herein can have physical properties better suited for application to an agricultural product (e.g., by spray-, brush-, or dip-coating).

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

The terms “a,” “an,” and “the” are used herein to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the term “about” allows for a degree of variability in a value or range within 10% of a stated value or of a stated limit of a range.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the term “monoglyceride” refers to the condensation product of one glycerol molecule and one fatty acid—that is, a glycerol group attached through an ester linkage to one fatty acid. Monoglycerides can, but need not necessarily, be derived from a condensation reaction. For example, monoglycerides can be obtained by an esterification reaction between glycerol and a fatty acid, by transesterification of a triglyceride with glycerol (glycerolysis), etc. Monoglycerides can also be referred to as glyceryl monoalkanoates. Where the glycerol group is attached to the ester linkage at the 1-position (e.g., as in 2,3-dihydroxypropan-1-yl octadecanoate), the monoglyceride can be referred to as a 1-monoglyceride or a 1-glyceryl alkanoate (e.g., as in 1-glyceryl octadecanoate). Where the glycerol group is attached to the ester linkage at the 2-position (e.g., as in 1,3-dihydroxypropan-2-yl hexadecanoate), the monoglyceride can be referred to as a 2-monoglyceride or a 2-glyceryl alkanoate (e.g., as in 2-glyceryl hexadecanoate). The glycerol group of a monoglyceride can be unsubstituted (e.g., as in a 2,3-dihydroxypropan-1-yl alkanoate), or can be further substituted with one or more groups other than a fatty acid (e.g., as in a 1,3-dialkoxypropan-2-yl alkanoate).

As used herein, the term “fatty alcohol” refers to primary alcohols having varying chain lengths ranging from 8 to 24 carbons and containing either saturated or unsaturated carbon bonds. Fatty alcohols can be naturally or non-naturally occurring, and can include a fatty alcohol chain that is branched or unbranched (e.g., linear), substituted or unsubstituted, and saturated or unsaturated.

As used herein, the term “fatty acid” refers to carboxylic acids having an aliphatic fatty acid chain. Fatty acids can be naturally or non-naturally occurring, and can include a fatty acid chain that is branched or unbranched (e.g., linear), substituted or unsubstituted, and saturated or unsaturated.

As used herein, the term “fatty acid chain” refers to the aliphatic portion of a fatty acid, or a portion thereof. Unless otherwise indicated, the fatty acid chain of a given fatty acid includes the carbon of the carboxylic acid group. For example, dodecanoic acid can be described as including a linear, saturated C₁₂ fatty acid chain, and can also be represented as R^{F}—C(O)OH, where R^{F} is a linear, saturated C₁₁ fatty acid chain. Fatty acid chains can be present in compounds other than fatty acids, such as, for example, esters or amides, and can, but need not necessarily be derived from a fatty acid. For example, dodecanamide can be described as an amide of a fatty acid, whether or not the compound was in fact derived from dodecanoic acid.

The term “branched,” used in reference to a fatty acid chain, refers to the presence of one or more C₁-C₃ alkyl branches on the fatty acid chain. The term “linear,” used in reference to a fatty acid chain, can be used interchangeably with “unbranched” and refers to the lack of any alkyl branches on the fatty acid chain. Branched fatty acid chains can be substituted (e.g., by one or more OH) or can include only C₁-C₃ alkyl branches, and can be saturated or unsaturated. Linear fatty acid chains can be substituted by groups other than C₁-C₃ alkyl (e.g., by one or more OH) or can be unsubstituted, and can be saturated or unsaturated.

The term “methyl-branched,” used in reference to a fatty acid chain, refers to the presence of one or more methyl branches on the fatty acid chain. Methyl-branched-chain fatty acid chains include “iso-branched” fatty acid chains having one methyl branch at the penultimate carbon, and “anteiso-branched” fatty acid chains having one methyl branch at the ante-penultimate carbon.

The term “salt,” used in reference to a disclosed compound (e.g., a fatty acid) refers to derivatives of the compound where the parent compound is modified by converting an existing acid or base moiety to its salt form. Examples of such salts include, but are not limited to, mineral or organic acid salts of basic residues such as amine, alkali, or organic salts of acidic residues such as carboxylic acids, and the like.

As used herein, the term “monoglyceride α-gel phase” refers to a metastable dispersion including faceted, unilamellar monoglyceride-containing vesicles, present in the dispersion as a major component having long-range order. Also as used herein, the term “monoglyceride liquid crystalline phase,” refers to a stable dispersion including as a major component disordered, round monoglyceride-containing vesicles. As the monoglyceride α-gel phase can be accessible by cooling a monoglyceride liquid crystalline phase, the term “α-gel transition temperature” refers to the maximum temperature at which a phase transition from a liquid crystalline phase dispersion to an α-gel phase dispersion can occur.

As used herein, the term “monoglyceride coagel phase” refers to a stable dispersion including as a major component a fibrous network of hydrated monoglyceride-containing crystals. As the monoglyceride liquid crystalline phase can be accessible by heating a monoglyceride coagel phase, the term “liquid crystalline transition temperature” refers to the minimum temperature at which a phase transition from a coagel phase dispersion to a liquid crystalline phase dispersion can occur.

Where certain features of the compounds described herein are disclosed in groups or in ranges, such disclosure includes each and every individual sub-combination of the members of such groups and ranges. For example, the term “C₁-C₆ alkyl” includes (without limitation) methyl, ethyl, C₃ alkyl, C₄ alkyl, C₅ alkyl, and C₆ alkyl.

As used herein, the term “n-membered,” where n is an integer, typically describes the number of ring-forming atoms in a moiety where the number of ring-forming atoms is n. For example, piperidinyl is an example of a 6-membered heterocycloalkyl ring.

As used herein, the term “substituted” means that an atom or group of atoms formally replaces hydrogen as a “substituent” attached to another group. “Substituted,” unless otherwise indicated, refers to any level of substitution, e.g., mono-, di-, tri-, tetra- or penta-substitution, where such substitution is permitted. The substituents are independently selected, and substitution may be at any chemically accessible position. Substitution at a given atom is limited by valency. The phrase “optionally substituted” means unsubstituted or substituted. A single divalent substituent, e.g., oxo, can replace two hydrogen atoms.

As used herein, the term “Cₙ-Cₘ” indicates a range which includes the endpoints, wherein n and m are integers and indicate the number of carbons. Examples include C₁-C₄, C₁-C₆ and the like.

As used herein, the term “alkyl” refers to a saturated hydrocarbon group that may be straight-chained or branched. The term “Cₙ-Cₘ alkyl” refers to an alkyl group having n to m carbon atoms. An alkyl group formally corresponds to an alkane with one C—H bond replaced by the point of attachment of the alkyl group to the remainder of the compound. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like.

As used herein, the term “alkoxy” refers to a group of formula —O-alkyl, wherein the alkyl group is as defined above. The term “Cₙ-Cₘ alkoxy” refers to an alkoxy group, the alkyl group of which has n to m carbons. Example alkoxy groups include methoxy, ethoxy, propoxy (e.g., n-propoxy and isopropoxy), t-butoxy and the like.

As used herein, the term “heterocycloalkyl” refers to a non-aromatic ring system (monocyclic, bicyclic, or polycyclic), which may optionally contain one or more alkenylene groups as part of the ring structure, which has at least one heteroatom ring member independently selected from nitrogen, sulfur, oxygen, and phosphorus. The term “n- to m-membered ring heterocycloalkyl” refers to a heterocycloalkyl that has n to m ring-forming atoms. Ring-forming carbon atoms and heteroatoms of a heterocycloalkyl group can be optionally oxidized to form an oxo or sulfido group or other oxidized linkage (e.g., C(O), S(O), C(S), S(O)₂, N-oxide, etc.) or a nitrogen atom can be quaternized. The heterocycloalkyl group can be attached through a ring-forming carbon atom or a ring-forming heteroatom. Heterocycloalkyl groups can include double bonds, for example, up to 3 double bonds. Examples of heterocycloalkyl groups include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1]heptanonyl, 3-azabicyclo[3.1.0]hexanyl, 3-azabicyclo[4.1.0]heptanyl, and the like. Further examples of heterocycloalkyl groups include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

### Compositions

Provided herein are compositions including one or more monoglycerides of a C₄-C₂₈ fatty acid and one or more C₈-C₂₄ fatty alcohols.

In some embodiments, the one or more monoglycerides are present in a total amount of about 30 wt % to about 98 wt % of the composition, for example, about 30 wt % to about 95 wt %, about 30 wt % to about 90 wt %, about 50 wt % to about 98 wt %, about 50 wt % to about 95 wt %, about 50 wt % to about 90 wt %, about 75 wt % to about 98 wt %, about 75 wt % to about 95 wt %, about 75 wt % to about 90 wt %, about 80 wt % to about 98 wt %, about 80 wt % to about 95 wt %, about 80 wt % to about 90 wt %, about 90 wt % to about 98 wt %, or about 90 wt % to about 95 wt % of the composition.

In some embodiments, the one or more monoglycerides are present in a total amount of about 70 wt % to about 98 wt % of the composition, for example, about 70 wt % to about 95 wt %, about 70 wt % to about 90 wt %, about 70 wt % to about 85 wt %, about 70 wt % to about 80 wt %, about 70 wt % to about 75 wt %, about 75 wt % to about 98 wt %, about 80 wt % to about 98 wt %, about 85 wt % to about 98 wt %, about 90 wt % to about 98 wt %, or about 95 wt % to about 98 wt % of the composition.

In some embodiments, the one or more C₈-C₂₄ fatty alcohols are present in a total amount of about 0.5 wt % to about 50 wt % of the composition, for example, about 0.5 wt % to about 45 wt %, about 0.5 wt % to about 40 wt %, about 0.5 wt % to about 35 wt %, about 0.5 wt % to about 30 wt %, about 0.5 wt % to about 25 wt %, about 0.5 wt % to about 20 wt %, about 0.5 wt % to about 15 wt %, about 0.5 wt % to about 10 wt %, about 0.5 wt % to about 1 wt %, about 1 wt % to about 50 wt %, about 10 wt % to about 50 wt %, about 15 wt % to about 50 wt %, about 20 wt % to about 50 wt %, about 25 wt % to about 50 wt %, about 30 wt % to about 50 wt %, about 35 wt % to about 50 wt %, about 40 wt % to about 50 wt %, or about 45 wt % to about 50 wt % of the composition.

In some embodiments, the one or more C₈-C₂₄ fatty alcohols are present in a total amount of about 5 wt % to about 40 wt % of the composition, for example, about 5 wt % to about 35 wt %, about 5 wt % to about 30 wt %, about 5 wt % to about 25 wt %, about 5 wt % to about 20 wt %, about 5 wt % to about 15 wt %, about 5 wt % to about 10 wt %, about 10 wt % to about 40 wt %, about 15 wt % to about 40 wt %, about 20 wt % to about 40 wt %, about 25 wt % to about 40 wt %, about 30 wt % to about 40 wt %, or about 35 wt % to about 40 wt % of the composition.

In some embodiments, the one or more C₈-C₂₄ fatty alcohols are present in a total amount of about 10 wt % to about 35 wt % of the composition, for example, about 10 wt % to about 30 wt %, about 10 wt % to about 25 wt %, about 10 wt % to about 20 wt %, about 10 wt % to about 15 wt %, about 15 wt % to about 35 wt %, about 20 wt % to about 35 wt %, about 25 wt % to about 35 wt %, or about 30 wt % to about 35 wt % of the composition.

In some embodiments, the one or more monoglycerides and the one of more fatty alcohols are present in a total amount of about 70 wt % to about 98 wt % of the composition, for example, about 70 wt % to about 95 wt %, about 70 wt % to about 90 wt %, about 70 wt % to about 85 wt %, about 70 wt % to about 80 wt %, about 70 wt % to about 75 wt %, about 75 wt % to about 98 wt %, about 80 wt % to about 98 wt %, about 85 wt % to about 98 wt %, about 90 wt % to about 98 wt %, or about 95 wt % to about 98 wt % of the composition.

In some embodiments, the composition further includes one or more salts of a C₄-C₂₈ fatty acid. In some embodiments, the one or more salts of a C₄-C₂₈ fatty acid are present in a total amount of about 0.5 wt % to about 15 wt % of the composition, for example, about 0.5 wt % to about 12.5 wt %, about 0.5 wt % to about 10 wt %, about 0.5 wt % to about 5 wt %, about 0.5 wt % to about 1 wt %, about 1 wt % to about 15 wt %, about 5 wt % to about 15 wt %, about 10 wt % to about 15 wt %, about 12.5 wt % to about 15 wt % of the composition.

In some embodiments, the one or more salts of a C₄-C₂₈ fatty acid are present in a total amount of about 1 wt % to about 10 wt % of the composition, for example, about 1 wt % to about 7.5 wt %, about 1 wt % to about 5 wt %, about 1 wt % to about 2.5 wt %, about 2.5 wt % to about 10 wt %, about 5 wt % to about 10 wt %, or about 7.5 wt % to about 10 wt % of the composition.

In some embodiments, a ratio of a total number of moles of the one or more monoglycerides to a total number of moles of the one or more fatty alcohols is about 40:1 to about 1:1, for example, about 35:1 to about 1:1, about 30:1 to about 1:1, about 25:1 to about 1:1, about 20:1 to about 1:1, about 15:1 to about 1:1, about 10:1 to about 1:1, about 5:1 to about 1:1, about 40:1 to about 2:1, about 40:1 to about 5:1, about 40:1 to about 10:1, about 40:1 to about 15:1, about 40:1 to about 20:1, about 40:1 to about 25:1, about 40:1 to about 30:1, or about 40:1 to about 35:1.

In some embodiments, a ratio of a total number of moles of the one or more monoglycerides to a total number of moles of the one or more fatty alcohols is about 30:1 to about 2:1, for example, about 25:1 to about 2:1, about 20:1 to about 2:1, about 15:1 to about 2:1, about 10:1 to about 2:1, about 5:1 to about 2:1, about 30:1 to about 5:1, about 30:1 to about 10:1, about 30:1 to about 15:1, about 30:1 to about 20:1, or about 30:1 to about 25:1.

In some embodiments, a ratio of a total number of moles of the one or more monoglycerides and the one or more fatty alcohols to a total number of moles of the one or more salts of a C₄-C₂₈ fatty acid is about 100:1 to about 4:1, for example, about 100:1 to about 10:1, about 100:1 to about 25:1, about 100:1 to about 50:1, about 100:1 to about 75:1, about 75:1 to about 4:1, about 50:1 to about 4:1, about 25:1 to about 4:1, or about 10:1 to about 4:1.

In some embodiments, a ratio of a total number of moles of the one or more monoglycerides and the one or more fatty alcohols to a total number of moles of the one or more salts of a C₄-C₂₈ fatty acid is about 50:1 to about 6:1, for example, about 40:1 to about 6:1, about 30:1 to about 6:1, about 20:1 to about 6:1, about 10:1 to about 6:1, about 50:1 to about 10:1, about 50:1 to about 20:1, about 50:1 to about 30:1, or about 50:1 to about 40:1.

In some embodiments, the one or more monoglycerides of a C₄-C₂₈ fatty acid, the one or more C₈-C₂₄ fatty alcohols, and the one or more salts of a C₄-C₂₄ fatty acid are present in a total amount of at least about 70 wt % of the composition, for example, at least about 75 wt %, at least about 80 wt %, at least about 85 wt %, at least about 90 wt %, at least about 95 wt %, at least about 97.5 wt %, at least about 98 wt %, or at least about 99 wt % of the composition.

In some embodiments, the at least one of the monoglycerides comprises a C₁₆-C₁₈ side chain and at least one of the fatty alcohols comprises a C₁₆-C₁₈ side chain, for example, at least one of the monoglycerides comprises a C₁₈ side chain and at least one of the fatty alcohols comprises a C₁₈ side chain.

In some embodiments, the side chain of at least one of the monoglycerides and the side chain of at least one of the fatty alcohols are the same, for example, the side chain of at least one of the monoglycerides is a C₁₆ side chain and the side chain of at least one of the fatty alcohols is a C₁₆ side chain, the side chain of at least one of the monoglycerides is a C₁₇ side chain and the side chain of at least one of the fatty alcohols is a C₁₇ side chain, or the side chain of at least one of the monoglycerides is a C₁₈ side chain and the side chain of at least one of the fatty alcohols is a C₁₈ side chain.

In some embodiments, the composition comprises two or more monoglycerides, one of which is a monoglyceride of a C₈-C₁₄ fatty acid. In some embodiments, the monoglyceride of the C₈-C₁₄ fatty acid are present in a total amount of about 1 wt % to about 25% of the total amount of the two or more monoglycerides in the composition, for example, about 1 wt % to about 20%, about 1 wt % to about 15%, about 1 wt % to about 10%, about 1 wt % to about 5%, about 5 wt % to about 25%, about 10 wt % to about 25%, about 15 wt % to about 25%, or about 20 wt % to about 25% of the total amount of the two or more monoglycerides in the composition.

In some embodiments, the composition can further contain an additional salt (e.g., as a diluent). For example, the compositions can comprise a salt such as chloride salts (e.g., lithium chloride, sodium chloride, potassium chloride, cesium chloride, magnesium chloride, calcium chloride), such as phosphate salts (e.g., lithium phosphate, sodium phosphate, potassium phosphate, cesium phosphate, calcium phosphate, magnesium phosphate, lithium diphosphate, sodium diphosphate, potassium diphosphate, cesium diphosphate, calcium diphosphate, magnesium diphosphate, dilithium hydrogen phosphate, disodium hydrogen phosphate, dipotassium hydrogen phosphate, lithium dihydrogen phosphate, sodium dihydrogen phosphate, potassium dihydrogen phosphate), such as sulfate salts (e.g., lithium sulfate, sodium sulfate, potassium sulfate, magnesium sulfate, calcium sulfate, lithium hydrogen sulfate, sodium hydrogen sulfate, potassium hydrogen sulfate, magnesium hydrogen sulfate, calcium hydrogen sulfate) and/or sulfite salts (e.g., lithium sulfite, sodium sulfite, potassium sulfite, lithium hydrogen sulfite, sodium hydrogen sulfite, potassium hydrogen sulfite). In some embodiments, the salt can comprise about 1%, about 2%, about 3%, about 4%, about 5%, less than about 5%, less than about 10%, less than about 20%, less than about 50%, between about 1% and about 5%, between about 1% and about 10%, between about 1% and about 20%, between about 1% and about 30%, between about 1% and about 40%, or between about 1% and about 50% of the weight percent of the composition. In some embodiments, the concentration of the salt in the composition is about 25 mg/L to about 1000 mg/L, about 50 mg/L to about 1000 mg/L, about 100 mg/L to about 1000 mg/L, about 250 mg/L to about 1000 mg/L, about 500 mg/L to about 1000 mg/L, about 750 mg/L to about 1000 mg/L, about 25 mg/L to about 750 mg/L, about 25 mg/L to about 500 mg/L, about 25 mg/L to about 250 mg/L, about 25 mg/L to about 100 mg/L, or about 25 mg/L to about 50 mg/L.

Monoglycerides of a C₄-C₂₈ Fatty Acid

The compositions described herein can include one or more monoglycerides of a C₄-C₂₈ fatty acid. In some embodiments, the composition includes one monoglyceride of a C₄-C₂₈ fatty acid. In some embodiments, the composition includes two, three, or more monoglycerides of a C₄-C₂₈ fatty acid, for example, two monoglycerides of a C₄-C₂₈ fatty acid. In some embodiments, the monoglycerides include one or more monoglycerides of a naturally occurring fatty acid.

The monoglycerides can include one or more 1-monoglycerides, one or more 2-monoglycerides, or a mixture thereof. In some embodiments, the monoglycerides include one or more 2,3-dihydroxypropan-1-yl esters of a fatty acid, one or more 1,3-dihydroxypropan-2-yl esters of a fatty acid, or a mixture thereof. In some embodiments, 1-monoglycerides make up at least about 50 wt %, at least about 70 wt %, at least about 80 wt %, at least about 90 wt %, or about 100 wt % of the monoglycerides present in the composition. In some embodiments, 1-monoglycerides make up about 70 wt % to about 100 wt %, about 70 wt % to about 90 wt %, about 75 wt % to about 100 wt %, about 75 wt % to about 90 wt %, about 80 wt % to about 100 wt %, or about 80 wt % to about 90 wt % of the monoglycerides present in the composition.

In some embodiments, the monoglycerides include one or more monoglycerides of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, one or more of the monoglycerides include an unsubstituted side chain, for example, an unsubstituted C₁₂-C₂₂ side chain. In some embodiments, one or more of the monoglycerides include a linear side chain, for example, a linear C₁₂-C₂₂ side chain. In some embodiments, one or more of the monoglycerides include a saturated side chain, for example, a saturated C₁₂-C₂₂ side chain.

In some embodiments, the monoglycerides include one or more compounds of Formula I-i:

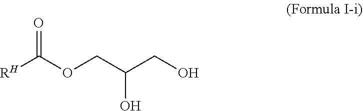

wherein R^{H} is a C₃-C₂₇ side chain.

In some embodiments, the monoglycerides include one or more compounds of Formula I-ii:

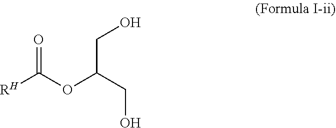

wherein R^{H} is a C₃-C₂₇ side chain.

In some embodiments, each of the one or more monoglycerides independently includes a compound of Formula I-i or Formula I-ii. In some embodiments of Formula I-i or Formula I-ii, R^{A1} and R^{A2} are each H. In some embodiments of Formula I-i or Formula I-ii, R^{H} is a saturated side chain. In some embodiments of Formula I-i or Formula I-ii, R^{H} is an unsubstituted side chain. In some embodiments of Formula I-i or Formula I-ii, R^{H} is a linear side chain. In some embodiments of Formula I-i or Formula I-ii, R^{H} is a C₁₅-C₂₇ side chain. In some embodiments of Formula I-i or Formula I-ii, R^{H} is a C₃-C₁₃ side chain.

In some embodiments, the monoglycerides include a first compound of Formula I-i or Formula I-ii, where R^{H} is a C₁₅-C₂₇ side chain; and a second compound of Formula I-i or Formula I-ii, where R^{H} is a C₃-C₁₃ side chain. In some embodiments, R^{H} of the first compound is a C₁₅-C₂₁ side chain, and R^{H} of the second compound is a C₁₁-C₁₃ side chain. In some embodiments, the second compound of formula I-i or Formula I-ii is present in a total amount of about 0.5 wt % to about 15 wt % of the composition, for example, about 1 wt % to about 10 wt %, or about 1 wt % to about 5 wt %, about 5 wt % to about 15 wt %, or about 5 wt % to about 10 wt % of the composition.

In some embodiments, the monoglycerides include one or more compounds of Formula IA-i:

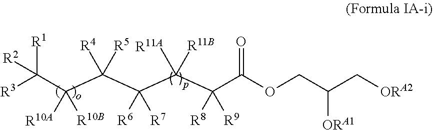

wherein:
R^{A1} and R^{A} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

In some embodiments, the monoglycerides include one or more compounds of Formula IA-ii:

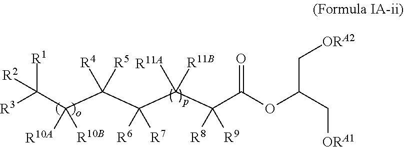

wherein:
R^{A1} and R^{A2} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

In some embodiments, each of the one or more monoglycerides independently includes a compound of Formula IA-i or Formula IA-ii. In some embodiments of Formula IA-i or Formula IA-ii, R^{A1} and R^{A2} are each H. In some embodiments of Formula IA-i or Formula IA-ii, each of R¹, R², R³, R⁴, R⁵, R⁶, R⁷, R⁸, and R⁹, and each occurrence of R^{11A}, R^{10B}, R^{11A} and R^{11B} are independently selected from H and OH. In some embodiments of Formula IA-i or Formula IA-ii, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IA-i or Formula IA-ii, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IA-i or Formula IA-ii, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the monoglycerides include one or more 1-monoglycerides or 2-monoglycerides, for example, 2,3-dihydroxypropan-1-yl esters or 1,3-dihydroxypropan-2-yl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid, or docosanoic acid.

### Fatty Alcohols

The compositions described herein include one or more C₈-C₂₄ fatty alcohols. In some embodiments, the one or more fatty alcohols each independently comprise a C₁₂-C₂₂ alcohol. In some embodiments, the one or more fatty alcohols each independently comprise a C₁₄-C₂₀ alcohol. In some embodiments, the one or more fatty alcohols each independently comprise a C₁₆ fatty alcohol or a C₁₈ fatty alcohol.

In some embodiments, each of the one or more fatty alcohols independently comprises a compound of Formula III:

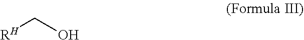

wherein:
R^{H} is a C₇-C₂₃ side chain.

In some embodiments, each of the one or more fatty alcohols independently includes a compound of Formula III. In some embodiments of Formula III, R^{H} is a saturated side chain. In some embodiments of Formula III, R^{H} is an unsubstituted side chain. In some embodiments of Formula III, R^{H} is a linear side chain. In some embodiments of Formula III, R^{H} is a C₁₆-C₂₂ side chain, C₁₅-C₂₁ side chain, a C₁₄-C₂₀ side chain, a C₁₆-C₂₀ side chain, or a C₁₁-C₁₉ side chain.

In some embodiments, each of the one or more fatty alcohols independently comprises a compound of Formula IIIA:

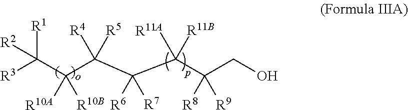

wherein:
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 15;
p is an integer from 0 to 15; and
the sum of o and p is from 3 to 15.

In some embodiments, each of the one or more fatty alcohols independently includes a compound of Formula IIIA. In some embodiments of Formula IIIA, R^{B} is C₁-C₅ alkyl, C₁-C₃ alkyl, C₂ alkyl, or C₃ alkyl. In some embodiments of Formula IIIA, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IIIA, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IIIA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IIIA, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IIIA, two, one, or none of R¹, R², R³, R⁴, R⁵, R⁶, R⁷, R⁸, and R⁹, and each occurrence of R^{10A}, R^{10B}, R^{11A}, and R^{11B} are —OH.

In some embodiments, the one or more C₈-C₂₄ fatty alcohols include 1-octanol, 1-nonanol, 1-decanol, 1-undecanol, 1-dodecanol, 1-tridecanol, 1-tetradecanol, 1-pentadecanol, 1-hexadecanol, cis-9-hexadecen-1-ol, 1-n-heptadecanol, 1-octadecanol, 1-octadecenol, 1-nonadecanol, 1-eicosanol, 1-heneicosanol, 1-docosanol, cis-13-docosen-1-ol, 1-tetracosanol, 1-hexacosanol, 1-heptacosanol, 1-octacosanol, or a combination thereof.

Salts of a C₄-C₂₈ Fatty Acid

The compositions described herein can include one or more salts of a C₄-C₂₈ fatty acid. In some embodiments, the composition includes one salt of a C₄-C₂₈ fatty acid. In some embodiments, the composition includes two, three, or more salts of a C₄-C₂₈ fatty acid, for example, two salts of a C₄-C₂₈ fatty acid. In some embodiments, the salts include one or more salts of a naturally occurring fatty acid.

In some embodiments, the salts include one or more salts of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, the salts include two salts of a C₁₂-C₂₂ fatty acid, for example, a salt of a C₁₆ fatty acid and a C₁₈ fatty acid. In some embodiments, one or more of the salts include an unsubstituted fatty acid chain, for example, an unsubstituted C₁₂-C₂₂ fatty acid chain. In some embodiments, one or more of the salts include a linear fatty acid chain, for example, a linear C₁₂-C₂₂ fatty acid chain. In some embodiments, one or more of the salts include a saturated fatty acid chain, for example, a saturated C₁₂-C₂₂ fatty acid chain.

In some embodiments, the salts include one or more compounds of Formula II:

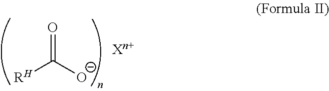

wherein:
R^{H} is a C₃-C₂₇ fatty acid chain; and
Xⁿ⁺ is a cationic moiety having formal charge n.

In some embodiments, each of the one or more salts independently includes a compound of Formula II. In some embodiments of Formula II, Xⁿ⁺ is selected from Li⁺, Na⁺, K⁺, Cs⁺ Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca²⁺, Mg²⁺, and Zn²⁺. In some embodiments of Formula II, R^{H} is a saturated fatty acid chain. In some embodiments of Formula II, R^{H} is an unsubstituted fatty acid chain. In some embodiments of Formula II, R^{H} is a linear fatty acid chain. In some embodiments of Formula II, R^{H} is a C₅-C₁₇ fatty acid chain. In some embodiments of Formula II, R^{H} is a C₁₁-C₂₁ fatty acid chain.

In some embodiments, the salts include one or more compounds of Formula IIA:

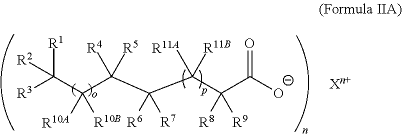

wherein:
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17;
the sum of o and p is from 0 to 17; and
Xⁿ⁺ is a cationic moiety having formal charge n.

In some embodiments, each of the one or more salts independently includes a compound of Formula IIA. In some embodiments of Formula IIA, Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca²⁺, Mg²⁺, and Zn²⁺.

In some embodiments of Formula IIA, each of R¹, R², R³, R⁴, R⁵, R⁶, R⁷, R⁸, and R⁹, and each occurrence of R^{11A}, R^{10B}, R^{11A}, and R^{11B} are independently selected from H and OH. In some embodiments of Formula IIA, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IIA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IIA, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IIA, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IIA, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the salts include one or more salts, for example, sodium, potassium, silver, calcium, magnesium, or zinc salts, of a saturated, linear, unsubstituted fatty acid. In some embodiments, the salts include one or more salts, for example, sodium, potassium, silver, calcium, magnesium, or zinc salts, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid, or docosanoic acid.

### Additional Components

The compositions described herein can include one or more additional components, for example, components that are non-toxic and safe for consumption by humans and/or animals. For example, the composition can include direct or indirect food additives or food-contact substances approved by the U.S. Food and Drug Administration (FDA), components satisfying FDA regulatory requirements to be used as a food additive or food contact substance, or components generally recognized as safe (GRAS) by the FDA.

In some embodiments, the compositions described herein further include one or more fatty acids, for example, C₄-C₂₂ fatty acids. In some embodiments, the composition includes less than about 10 wt %, for example, less than about 5 wt %, less than about 2 wt %, less than about 1 wt %, or is free from one or more of triglycerides, diglycerides, acetylated monoglycerides, lactylated monoglycerides, succinylated monoglycerides, sterols, bile acids, proteins, polysaccharides, phenols, lignans, aromatic acids, terpenoids, flavonoids, carotenoids, alkaloids, alcohols, alkanes, aldehydes, and any salts thereof.

In some embodiments, the composition (e.g., a coating or coating agent) comprises one or more (e.g., 1, 2, or 3) wetting agents, surfactants, and/or emulsifiers. In some embodiments, the one or more wetting agents, surfactants, and/or emulsifiers comprise sodium bicarbonate, citric acid, cetyl trimethylammonium bromide, sodium lauryl sulfate, ammonium lauryl sulfate, sodium laureth sulfate, sodium myreth sulfate, docusate, sodium dodecyl sulfate, sodium stearate, sodium lauroyl sarcosinate, perfluorononanoate, perfluorooctanoate, perfluorooctanesulfonate (PFOS), perfluorobutanesulfonate, alkyl-aryl ether phosphates, alkyl ether phosphates, 2-[4-(2,4,4-trimethylpentan-2-yl)phenoxy]ethanol (Triton X-100), 3-[(3-Cholamidopropyl)dimethylammonio]-1-propanesulfonate (CHAPS), cholic acid, nonyl phenoxypolyethoxylethanol (NP-40), octyl thioglucoside, octyl glucoside, dodecyl maltoside, octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB), cocamidopropyl hydroxysultaine, cocamidopropyl betaine, phosphatidylserine, phosphatidylethanolamine, phosphatidylcholine, phosphatidylinositol, phosphatidic acid, lysophosphatidylserine, lysophosphatidylethanolamine, lysophosphatidylcholine, lysophosphatidylinositol, lysophosphatidic acid, sphingomyelins, lauryldimethylamine oxide, myristamine oxide, octaethylene glycol monododecyl ether, pentaethylene glycol monododecyl ether, polyethoxylated tallow amine, cocamide monoethanolamine, cocamide diethanolamine, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, Tween 20, Tween 40, Tween 60, Tween 80, alkyl polyglucosides, alkyl polyglycosides, decyl glucoside, lauryl glucoside, octyl glucoside, fatty acid esters of sucrose, sucrose monostearate, sucrose di stearate, sucrose tri stearate, sucrose polystearate, sucrose monopalmitate, sucrose dipalmitate, sucrose tripalmitate, sucrose polypalmitate, sucrose monomyristate, sucrose dimyristate, sucrose trimyristate, sucrose polymyristate, sucrose monolaurate, sucrose dilaurate, sucrose trilaurate, or sucrose polylaurate. For example, the one or more wetting agents, surfactants, and/or emulsifiers comprises sodium lauryl sulfate. For example, the one or more wetting agents, surfactants, and/or emulsifiers comprises sodium bicarbonate. For example, the one or more wetting agents, surfactants, and/or emulsifiers comprises citric acid.

In some embodiments, the composition (e.g., a coating or coating agent) comprises from about 0.1% to about 40% by weight of the one or more wetting agents, surfactants, and/or emulsifiers. For example, the mixture or composition (e.g., coating or coating agent) comprises from about 0.1% to about 35%, from about 0.1% to about 30%, from about 0.1% to about 25%, from about 0.1% to about 20%, from about 0.1% to about 15%, from about 0.1% to about 10%, from about 0.1% to about 8%, from about 0.1% to about 6%, from about 0.1% to about 5%, from about 0.1% to about 4%, from about 0.1% to about 3%, from about 0.1% to about 2%, from about 0.1% to about 1%, from about 0.1% to about 0.5%, from about 1% to about 40%, from about 1% to about 30%, from about 1% to about 20%, from about 1% to about 15%, from about 1% to about 10%, from about 1% to about 5%, from about 3% to about 9%, from about 5% to about 10%, from about 10% to about 20%, from about 20% to about 30%, from about 30% to about 40%, from about 20% to about 40%, from about 25% to about 35%, about 0.1%, about 1%, about 2%, about 3%, about 4%, about 5%, about 6%, about 7%, about 8%, about 9%, about 29%, about 30%, or about 31%.

### Mixtures

Also provided herein are mixtures including a composition described herein and a solvent. In some embodiments, the mixture includes a dispersion of a composition described herein in a solvent. In some embodiments, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments, the solvent includes water, ethanol, or a combination thereof.

In some embodiments, the mixture includes about 30 wt % to about 99.9 wt %, about 30 wt % to about 99.5 wt %, about 30 wt % to about 99 wt %, about 50 wt % to about 99.9 wt %, about 50 wt % to about 99.5 wt %, about 50 wt % to about 99 wt %, about 90 wt % to about 99.9 wt %, about 90 wt % to about 99.5 wt %, or about 90 wt % to about 99 wt % of solvent.

In some embodiments, the concentration of the composition in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments, the mixture includes a monoglyceride α-gel phase. In some embodiments, the mixture includes a monoglyceride liquid crystalline phase, and an α-gel transition temperature of the liquid crystalline phase is at most about 75° C., for example, at most about 70° C., at most about 65° C., at most about 60° C., at most about 55° C., at most about 50° C., or at most about 45° C. In some embodiments, the mixture includes a monoglyceride coagel phase, and a liquid crystalline transition temperature of the coagel phase is at most about 80° C., for example, at most about 75° C., at most about 70° C., at most about 65° C., at most about 60° C., at most about 55° C., or at most about 50° C.

### Coatings

Also provided herein are coated agricultural products including a layer formed from a composition described herein, disposed on a surface of the agricultural product. In some embodiments, the agricultural product is an edible agricultural product including, for example, fruits, vegetables, edible seeds and nuts, herbs, spices, produce, meat, eggs, dairy products, seafood, grains, or any other consumable item. In other embodiments, the agricultural product is an inedible agricultural product including, for example, inedible flowers, seeds, shoots, stems, leaves, whole plants, and the like. In some embodiments, the layer is disposed on an exterior surface (e.g., a cuticular surface) of the agricultural product.

In some embodiments, the layer has a thickness of about 0.1 μm to about 20 μm, for example, about 0.1 μm to about 15 μm, about 0.1 μm to about 10 μm, about 0.5 μm to about 20 μm, about 0.5 μm to about 15 μm, about 0.5 μm to about 10 μm, about 1 μm to about 20 μm, about 1 μm to about 15 μm, or about 1 μm to about 10 μm.

### Coating Methods

Also provided herein are methods for coating an agricultural product, the methods including contacting a surface of the agricultural product with a mixture including a coating agent and a solvent (e.g., a mixture described herein), and removing at least a portion of the solvent to form a coating on the surface of the agricultural product. The coating agent includes one or more monoglycerides of a C₄-C₂₈ fatty acid and one or more C₈-C₂₄ fatty alcohols. In some embodiments, the coating agent is a composition described herein. For example, in some embodiments, a ratio of a total number of moles of the one or more monoglycerides of a C₄-C₂₈ fatty acid to a total number of moles of the one or more C₈-C₂₄ fatty alcohols is about 40:1 to about 1:1. In some embodiments, the coating agent includes one or more monoglycerides of a linear C₄-C₂₈ fatty acid, present in a total amount of about 30 wt % to about 98 wt % of the coating agent, and one or more C₈-C₂₄ fatty alcohols, present in a total amount of about 1 wt % to about 50 wt % of the coating agent.

In some embodiments of the coating method, the agricultural product is an edible agricultural product including, for example, fruits, vegetables, edible seeds and nuts, herbs, spices, produce, meat, eggs, dairy products, seafood, grains, or any other consumable item. In other embodiments of the coating method, the agricultural product is an inedible agricultural product including, for example, inedible flowers, seeds, shoots, stems, leaves, whole plants, and the like. In some embodiments, the method includes contacting an exterior surface (e.g., a cuticular surface) of the agricultural product with the coating agent-containing mixture.

In some embodiments of the coating method, contacting the surface of the agricultural product includes spraying the mixture onto the surface of the agricultural product. The mixture can be sprayed, for example, from a commercially available sprayer. In some embodiments, the mixture is aerosol-sprayed onto the surface of the agricultural product. In some embodiments of the coating method, contacting the surface of the agricultural product includes immersing the agricultural product in the mixture. In other embodiments of the coating method, the mixture can be brushed, dripped, drop-cast, rolled, dabbed, or poured on the surface of the agricultural product.

In some embodiments of the coating method, removing at least a portion of the solvent includes evaporating at least a portion of solvent. In some embodiments, the evaporation can be passive. In other embodiments, the evaporation can be active, for example, as in convective drying. In some embodiments of the coating method, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments of the coating method, the solvent includes water, ethanol, or a combination thereof.

In some embodiments of the coating method, the concentration of the coating agent in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments, the one or more C₈-C₂₄ fatty alcohols are present in a total amount of about 0.5 wt % to about 50 wt % of the coating agent, for example, about 0.5 wt % to about 45 wt %, about 0.5 wt % to about 40 wt %, about 0.5 wt % to about 35 wt %, about 0.5 wt % to about 30 wt %, about 0.5 wt % to about 25 wt %, about 0.5 wt % to about 20 wt %, about 0.5 wt % to about 15 wt %, about 0.5 wt % to about 10 wt %, about 0.5 wt % to about 1 wt %, about 1 wt % to about 50 wt %, about 10 wt % to about 50 wt %, about 15 wt % to about 50 wt %, about 20 wt % to about 50 wt %, about 25 wt % to about 50 wt %, about 30 wt % to about 50 wt %, about 35 wt % to about 50 wt %, about 40 wt % to about 50 wt %, or about 45 wt % to about 50 wt % of the coating agent.

In some embodiments, the one or more C₈-C₂₄ fatty alcohols are present in a total amount of about 5 wt % to about 40 wt % of the coating agent, for example, about 5 wt % to about 35 wt %, about 5 wt % to about 30 wt %, about 5 wt % to about 25 wt %, about 5 wt % to about 20 wt %, about 5 wt % to about 15 wt %, about 5 wt % to about 10 wt %, about 10 wt % to about 40 wt %, about 15 wt % to about 40 wt %, about 20 wt % to about 40 wt %, about 25 wt % to about 40 wt %, about 30 wt % to about 40 wt %, or about 35 wt % to about 40 wt % of the coating agent.

In some embodiments, the one or more C₈-C₂₄ fatty alcohols are present in a total amount of about 10 wt % to about 35 wt % of the coating agent, for example, about 10 wt % to about 30 wt %, about 10 wt % to about 25 wt %, about 10 wt % to about 20 wt %, about 10 wt % to about 15 wt %, about 15 wt % to about 35 wt %, about 20 wt % to about 35 wt %, about 25 wt % to about 35 wt %, or about 30 wt % to about 35 wt % of the coating agent.

In some embodiments, the ratio of the total number of moles of the one or more monoglycerides to the total number of moles of the one or more fatty alcohols present in the coating agent is about 30:1 to about 1:1, or about 15:1 to about 1:1. In some embodiments, the ratio of the total number of moles of the one or more monoglycerides and the one or more fatty alcohols to the total number of moles of the one or salts present in the coating agent is about 100:1 to about 4:1, or about 50:1 to about 6:1.

In some embodiments, the monoglycerides include a compound of Formula I-i, Formula I-ii, Formula IA-i, or Formula IA-ii described herein. In some embodiments, the fatty alcohols include a compound of Formula III or Formula IIIA described herein. In some embodiments, the coating agent further includes a compound of Formula II or Formula IIA described herein.

In some embodiments, the one or more monoglycerides and the one or more fatty alcohols make up about 70 wt % to about 99 wt % of the coating agent, for example, about 70 wt % to about 98 wt %, about 70 wt % to about 96 wt %, about 80 wt % to about 99 wt %, about 80 wt % to about 98 wt %, about 80 wt % to about 96 wt %, about 85 wt % to about 99 wt %, about 85 wt % to about 98 wt %, or about 85 wt % to about 96 wt % of the coating agent. In some embodiments, the coating agent further includes one or more salts of a C₄-C₂₈ fatty acid, and the one or more monoglycerides, the one or more fatty alcohols, and the one or more salts make up at least about 80 wt % of the coating agent, for example, at least about 85 wt %, at least about 90 wt %, at least about 95 wt %, at least about 97.5 wt %, at least about 98 wt %, or at least about 99 wt % of the coating agent.

### EXAMPLES

### Example 1. Preparation of Mixtures

Coating agents A-M were prepared according to Tables 1-3.

TABLE 1
Coating Agent Compositions

| | A | | B | | C | | D | | E | |
|---|---|---|---|---|---|---|---|---|---|---|
| 2,3-dihydroxypropyl | 95 | wt % | 70 | wt % | 70 | wt % | 70 | wt % | 70 | wt % |
| stearate | | | | | | | | | | |
| sodium | 5 | wt % | 5 | wt % | 5 | wt % | 5 | wt % | 5 | wt % |
| octadecanoate | | | | | | | | | | |

| | | | | | | |
|---|---|---|---|---|---|---|
| 1-tetradecanol | — | 25 | wt % | — | — | — |

| | | | | | | |
|---|---|---|---|---|---|---|
| 1-hexadecanol | — | — | 25 | wt % | — | — |

| | | | | | | |
|---|---|---|---|---|---|---|
| 1-octadecanol | — | — | — | 25 | wt % | — |

| | | | | | | |
|---|---|---|---|---|---|---|
| 1-docosanol | — | — | — | — | 25 | wt % |

TABLE 2
Coating Agent Compositions

| | F | | G | | H | | I | |
|---|---|---|---|---|---|---|---|---|
| 2,3-dihydroxypropyl | 90 | wt % | 80 | wt % | 70 | wt % | 60 | wt % |
| stearate | | | | | | | | |
| sodium | 5 | wt % | 5 | wt % | 5 | wt % | 5 | wt % |
| octadecanoate | | | | | | | | |
| 1-octadecanol | 5 | wt % | 15 | wt % | 25 | wt % | 35 | wt % |

TABLE 3
Coating Agent Compositions

| | J | | K | | L | | M | |
|---|---|---|---|---|---|---|---|---|
| 2,3-dihydroxypropyl | 94 | wt % | 94 | wt % | 95 | wt % | 70 | wt % |
| stearate | | | | | | | | |
| sodium | 6 | wt % | 6 | wt % | 5 | wt % | 5 | wt % |
| octadecanoate | | | | | | | | |

| | | | | | | |
|---|---|---|---|---|---|---|
| 1-octadecanol | — | 25 | wt % | — | 25 | wt % |

| | | | | | | |
|---|---|---|---|---|---|---|
| glyceryl | — | — | 2.5 | g/L | 2.5 | g/L |
| monolaurate* | | | | | | |

*mixture of 2,3-dihydroxypropan-1-yl laurate and 1,3-dihydroxypropan-2-yl laurate (molar ratio of about 85:15 to about 95:5)

### Example 2. Stability Evaluation; Alcohol Chain Length

Mixtures 1-5 of coating agents A-E dispersed in water were prepared according to Table 4. The turbidity of the mixtures was measured daily and normalized to allow for comparison. Daily visual inspection of mixtures 1-5 was performed in parallel with turbidity measurements. Based on the change on turbidity over time and the absence/appearance of flocculate or precipitate, the maximum stability of the mixtures was determined in days. Phase transition temperatures (between the α-gel phase and the liquid crystalline phase) for each of mixtures 1-5 were determined by differential scanning calorimetry (DSC) immediately after preparation. Results are shown in Table 4.

TABLE 4
Mixture Compositions; Properties of Mixtures

| | | | | Transition |
|---|---|---|---|---|
| | Coating | Concentration | Stability | Temperature |
| | Agent | (g/L) | (days) | (° C.) |
| Mixture 1 | A | 50 | 11 | 59.5 |
| Mixture 2 | B | 50 | 7.5 | 58.6 |
| Mixture 3 | C | 50 | 17 | 64.7 |
| Mixture 4 | D | 50 | 30 | 68.4 |
| Mixture 5 | E | 50 | 15 | 68.5 |

As shown in Table 4, coatings formed from mixtures 3, 4, and 5, including a fatty alcohol with a C₁₆, Cis, or C₂₂ side chain, respectively, tended to demonstrate increased stability and transition temperatures. By contrast, the coating formed from mixture 2, including a fatty alcohol with a C₁₄ side chain demonstrated decreased stability and transition temperature.

### Example 3. Stability Evaluation; Alcohol Concentration

Mixtures 1 and 6-9 of coating agents A and F—I dispersed in water were prepared according to Table 5. The turbidity of the mixtures was measured daily and normalized to allow for comparison. Daily visual inspection of mixtures 1 and 6-9 was performed in parallel with turbidity measurements. Based on the change on turbidity over time and the absence/appearance of flocculate or precipitate, the maximum stability of the mixtures was determined in days. Phase transition temperatures (between the α-gel phase and the liquid crystalline phase) for each of mixtures 1 and 6-9 were determined by differential scanning calorimetry (DSC) immediately after preparation. Results are shown in Table 5.

TABLE 5
Mixture Compositions; Properties of Mixtures

| | | | | Transition |
|---|---|---|---|---|
| | Coating | Concentration | Stability | Temperature |
| | Agent | (g/L) | (days) | (° C.) |
| Mixture 1 | A | 50 | 11 | 59.5 |
| Mixture 6 | F | 50 | 11 | 61.4 |
| Mixture 7 | G | 50 | 13 | 65.6 |
| Mixture 8 | H | 50 | 30 | 68.4 |
| Mixture 9 | I | 50 | 43 | 70.9 |

As shown in Table 5, coatings formed from mixtures 6, 7, 8, and 9, including 5 wt %, 15 wt %, 25 wt %, and 35 wt %, respectively, of a fatty alcohol with a C₁₈ side chain showed an increase in stability and transition temperatures.

### Example 4. Coated Limes

Mixtures 11 and 12 of coating agents A and D dispersed in water were prepared according to Table 6. The solutions were prepared via high shear mixing in a blender, stored at ambient conditions (˜20° C.) overnight, and used for treatment the following day. For each of mixtures 11 and 12, limes were coated by dipping into a bowl of the mixture. Limes were conveyed through a drier set at 70° C. for a residence time of ˜120 seconds. Limes were then held at ambient conditions for subsequent days until the mass measurements were performed. Mass loss of the coated limes and a comparative group of uncoated limes was then measured. Results are shown in Table 6.

TABLE 6
Mixture Compositions; Mass Loss of Limes

| | | Concentration | Mass Loss |
|---|---|---|---|
| | Coating Agent | (g/L) | Factor* |
| Mixture 11 | A | 50.0 | 1.79 |
| Mixture 12 | D | 50.0 | 1.73 |
| Untreated | — | — | 1.00 |

*ratio of the average mass loss rate of untreated control to the average mass loss rate of corresponding tested produce for a given period of time

As demonstrated in Table 6, coatings described herein reduced mass loss from produce compared to untreated produce.

### Example 5. Stability Evaluation; Glyceryl Monolaurate-Containing Mixtures

Mixtures 13, 14, 15, 16, 17, and 18 containing coating agents J, K, A, D, L, and M, respectively, dispersed in water were prepared according to Table 7. The turbidity of the mixtures was measured daily and normalized to allow for comparison. Daily visual inspection of mixtures 13-18 was performed in parallel with turbidity measurements. Based on the change on turbidity over time and the absence/appearance of flocculate or precipitate, the maximum stability of the mixtures was determined in days. Phase transition temperatures (between the α-gel phase and the liquid crystalline phase) for each of mixtures 13-18 were determined by differential scanning calorimetry (DSC) immediately after preparation. Results are shown in Table 7.

TABLE 7
Mixture Compositions; Properties of Mixtures

| | | Concentration | Stability |
|---|---|---|---|
| | Coating Agent | (g/L) | (days) |
| Mixture 13 | J | 50 | 5 |
| Mixture 14 | K | 50 | 15 |
| Mixture 15 | A | 50 | 11 |
| Mixture 16 | D | 50 | 30 |
| Mixture 17 | L | 50 | 8 |
| Mixture 18 | M | 50 | 31 |

As shown in Table 7, coatings formed from coating agents including glyceryl monolaurate demonstrated similar performance compared to those lacking glyceryl monolaurate.

### Additional Embodiments

Although the disclosed inventive concepts include those defined in the attached claims, it should be understood that the inventive concepts can also be defined in accordance with the following embodiments.

In addition to the embodiments of the attached embodiments and the embodiments described above, the following numbered embodiments are also innovative.

Embodiment 1 is a composition comprising:
one or more monoglycerides of a C₄-C₂₈ fatty acid, present in a total amount of about 30 wt % to about 98 wt % of the composition; and
one or more C₈-C₂₄ fatty alcohols, present in a total amount of about 1 wt % to about 50 wt % of the composition.

Embodiment 2 is the composition of embodiment 1, wherein the one or more fatty alcohols are present in a total amount of about 5 wt % to about 40 wt % of the composition.

Embodiment 3 is the composition of embodiment 1 or embodiment 2, wherein the one or more fatty alcohols are present in a total amount of about 10 wt % to about 35 wt % of the composition.

Embodiment 4 is the composition of any one of embodiments 1-3, wherein the one or more monoglycerides are present in a total amount of about 70 wt % to about 98 wt % of the composition.

Embodiment 5 is the composition of any one of embodiments 1-4, wherein the one or more monoglycerides and the one or more fatty alcohols are present in a total amount of about 70 wt % to about 98% of the composition.

Embodiment 6 is the composition of any one of embodiments 1-5, further comprising one or more salts of a C₄-C₂₈ fatty acid.

Embodiment 7 is the composition of embodiment 6, wherein the one or more salts of C₄-C₂₈ fatty acid are present in a total amount of about 0.5 wt % to about 15 wt % of the composition.

Embodiment 8 is the composition of embodiment 6, wherein the one or more salts of C₄-C₂₈ fatty acid are present in a total amount of about 1 wt % to about 10 wt % of the composition.

Embodiment 9 is a composition comprising:
one or more monoglycerides of a C₄-C₂₈ fatty acid; and
one or more C₈-C₂₄ fatty alcohols;
wherein a ratio of a total number of moles of the one or more monoglycerides to a total number of moles of the one or more fatty alcohols is about 40:1 to about 1:1.

Embodiment 10 is the composition of embodiment 9, wherein the ratio of the total number of moles of the one or more monoglycerides to the total number of moles of the one or more fatty alcohols is about 30:1 to about 2:1.

Embodiment 11 is the composition of embodiment 9, wherein the ratio of the total number of moles of the one or more monoglycerides to the total number of moles of the one or more fatty alcohols is about 15:1 to about 2:1.

Embodiment 12 is the composition of any one of embodiments 9-11, wherein the one or more monoglycerides and the one or more fatty alcohols are present in a total amount of about 70 wt % to about 98 wt % of the composition.

Embodiment 13 is the composition of any one of embodiments 9-12, further comprising one or more salts of a C₄-C₂₈ fatty acid.

Embodiment 14 is the composition of embodiment 13, wherein a ratio of a total number of moles of the one or more monoglycerides and the one or more fatty alcohols to a total number of moles of the one or more salts is about 100:1 to about 4:1.

Embodiment 15 is the composition of embodiment 13, wherein a ratio of a total number of moles of the one or more monoglycerides and the one or more fatty alcohols to a total number of moles of the one or more salts is about 50:1 to about 6:1.

Embodiment 16 is the composition of any one of embodiments 13-15, wherein the one or more monoglycerides, the one or more fatty alcohols, and the one or more salts are present in a total amount of at least about 80 wt % of the composition.

Embodiment 17 is the composition of any one of embodiments 1-16, wherein the one or more fatty alcohols each independently comprise a C₁₂-C₂₂ fatty alcohol.

Embodiment 18 is the composition of any one of embodiments 1-16, wherein the one or more fatty alcohols each independently comprise a C₁₄-C₂₀ fatty alcohol.

Embodiment 19 is the composition of any one of embodiments 1-16, wherein the one or more fatty alcohols each independently comprise a C₁₆ fatty alcohol or a C₁₈ fatty alcohol.

Embodiment 20 is the composition of any one of embodiments 1-19, wherein at least one of the fatty alcohols comprises a linear side chain.

Embodiment 21 is the composition of any one of embodiments 1-20, wherein at least one of the fatty alcohols comprises a saturated, unsubstituted side chain.

Embodiment 22 is the composition of any one of embodiments 1-21, wherein at least one of the monoglycerides comprises a C₁₆-C₁₈ side chain and at least one of the fatty alcohols comprises a C₁₆-C₁₈ side chain.

Embodiment 23 is the composition of any one of embodiments 1-22, wherein the side chain of at least one of the monoglycerides and the side chain of at least one of the fatty alcohols are the same.

Embodiment 24 is the composition of embodiment 23, wherein the side chain is a C₁₆ side chain.

Embodiment 25 is the composition of embodiment 23, wherein the side chain is a C₁₈ side chain.

Embodiment 26 is the composition of embodiment 23, wherein the side chain is a C₂₂ side chain.

Embodiment 27 is the composition of any one of embodiments 1-26, wherein the composition comprises two or more monoglycerides, one of which is a monoglyceride of a C₈-C₁₄ fatty acid.

Embodiment 28 is the composition of embodiment 27, wherein the monoglyceride of the C₈-C₁₄ fatty acid are present in a total amount of about 1 wt % to about 25% of the total amount of the two or more monoglycerides in the composition.

Embodiment 29 is the composition of embodiment 27, wherein the monoglyceride of the C₈-C₁₄ fatty acid are present in a total amount of about 5 wt % to about 20% of the total amount of the two or more monoglycerides in the composition.

Embodiment 30 is the composition of any one of embodiments 1-29, wherein each of the one or more fatty alcohols independently comprises a compound of Formula III:

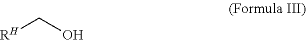

wherein R^{H} is a C₇-C₂₃ side chain.

Embodiment 31 is the composition of embodiment 30, wherein R^{H} is saturated, unsubstituted side chain.

Embodiment 32 is the composition of embodiment 30, wherein R^{H} is a C₁₄-C₂₀ side chain.

Embodiment 33 is the composition of embodiment 30, wherein R^{H} is a C₁₆ side chain or a C₁₈ side chain.

Embodiment 34 is the composition of any one of embodiments 1-33, wherein each of the one or more fatty alcohols independently comprises a compound of Formula IIIA:

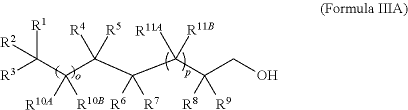

wherein:
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A} and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 15;
   p is an integer from 0 to 15; and
   the sum of o and p is from 3 to 15.

Embodiment 35 is the composition of embodiment 1-34, wherein each of the one or more monoglycerides independently comprises a compound of Formula I-i or Formula I-ii:

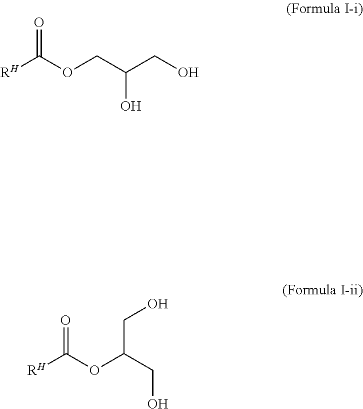

wherein R^{H} is a C₃-C₂₇ side chain.

Embodiment 36 is the composition of embodiment 35, wherein R^{H} is a saturated, unsubstituted side chain.

Embodiment 37 is the composition of embodiment 35 or embodiment 36, wherein R^{H} is a C₁₁-C₂₁ side chain.

Embodiment 38 is the composition of any one of embodiments 35-37, wherein the one or more monoglycerides comprises:
a first compound of Formula I-i or Formula I-ii, wherein R^{H} is a C₁₅-C₂₇ side chain; and
a second compound of Formula I-i or Formula I-ii, wherein R^{H} is a C₃-C₁₃ side chain.

Embodiment 39 is the composition of any one of embodiments 1-34, wherein each of the one or more monoglycerides independently comprises a compound of Formula IA-i or Formula IA-ii:

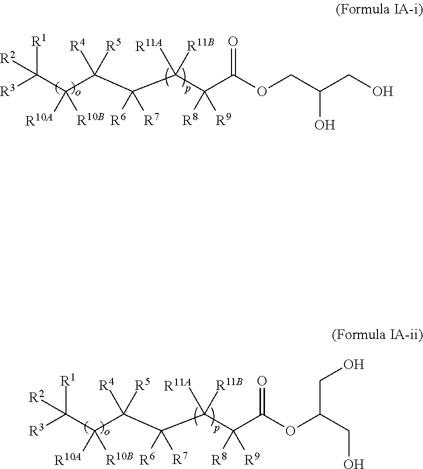

wherein:
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

Embodiment 40 is the composition of any one of embodiments 6-8 or 13-40, wherein each of the one or more salts present in the composition independently comprises a compound of Formula II:

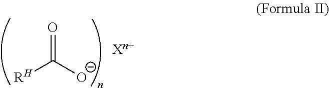

wherein:
   each R^{H} is independently a C₃-C₂₇ side chain; and
   Xⁿ⁺ is a cationic moiety having formal charge n.

Embodiment 41 is the composition of embodiment 40, wherein:
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and
each occurrence of R^{D} is independently selected from H, C₁-C₆ alkyl, C₃-C₆ cycloalkyl, C₃-C₆ heterocycloalkyl, aryl, and heteroaryl, wherein:
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 42 is the composition of embodiment 40 or embodiment 41, wherein each R^{H} is independently a saturated or unsubstituted side chain.

Embodiment 43 is the composition of any one of embodiments 1-42, wherein each of the one or more salts present in the composition independently comprises a compound of Formula IIA:

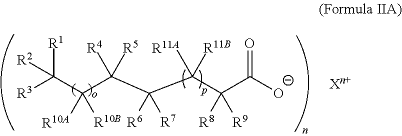

wherein:
   each R¹, R², R³, R⁴, R⁵, R⁶, R⁷, R⁸, and R⁹ are independently selected from H, OH, C₁-C₆ alkyl, C₂-C₆ alkenyl, and C₁-C₆ alkoxy;
   each occurrence of R^{10A}, R^{10B}, R^{11A} and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17;
   the sum of o and p is from 0 to 17; and
   Xⁿ⁺ is a cationic moiety having formal charge n.

Embodiment 44 is the composition of embodiment 43, wherein:
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and
each occurrence of R^{D} is independently selected from H, C₁-C₆ alkyl, C₃-C₆ cycloalkyl, C₃-C₆ heterocycloalkyl, aryl, and heteroaryl, wherein:
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 45 is a mixture comprising:
the composition of any one of embodiments 1-44; and
a solvent.

Embodiment 46 is a mixture comprising:
one or more monoglycerides of a C₄-C₂₈ fatty acid, present in a total amount of about 30 wt % to about 98 wt % of the mixture, and one or more C₈-C₂₄ fatty alcohols, present in a total amount of about 1 wt % to about 50 wt % of the mixture; or
one or more monoglycerides of a C₄-C₂₈ fatty acid and one or more C₈-C₂₄ fatty alcohols, wherein a ratio of a total number of moles of the one or more monoglycerides to a total number of moles of the one or more fatty alcohols is about 40:1 to about 1:1; and
a solvent.

Embodiment 47 is the mixture of embodiment 45 or embodiment 46, wherein the mixture comprises about 30 wt % to about 99.9 wt % of the solvent.

Embodiment 48 is the mixture of any one of embodiments 45-47, wherein the mixture comprises about 90 wt % to about 99.5 wt % of the solvent.

Embodiment 49 is the mixture of any one of embodiments 45-48, wherein the solvent comprises one or more of water, methanol, ethanol, isopropanol, butanol, acetone, ethyl acetate, chloroform, acetonitrile, tetrahydrofuran, diethyl ether, and methyl tert-butyl ether.

Embodiment 50 is the mixture of any one of embodiments 45-49, wherein the mixture comprises a monoglyceride liquid crystalline phase, and an α-gel transition temperature of the liquid crystalline phase is greater than about 60° C.

Embodiment 51 is the mixture of any one of embodiments 45-49, wherein the mixture comprises a monoglyceride liquid crystalline phase, and an α-gel transition temperature of the liquid crystalline phase is between about 60° C. and about 70° C.

Embodiment 52 is the mixture of any one of embodiments 45-49, wherein the mixture comprises a monoglyceride liquid crystalline phase, and an α-gel transition temperature of the liquid crystalline phase is between about 64° C. and about 70° C.

Embodiment 53 is a coated agricultural product comprising an agricultural product and a layer disposed on a surface of the agricultural product, wherein the layer comprises the mixture of any one of embodiments 45-52.

Embodiment 54 is the coated agricultural product of embodiment 53, wherein the layer is disposed on a cuticular surface of the agricultural product.

Embodiment 55 is the coated agricultural product of embodiment 53 or embodiment 54, wherein a thickness of the layer is in a range of about 0.1 μm to about 20 μm.

Embodiment 56 is the coated agricultural product of any one of embodiments 53-55, wherein a thickness of the layer is in a range of about 0.1 μm to about 10 μm.

Embodiment 57 is a method of coating an agricultural product, the method comprising:
contacting a surface of the agricultural product with a mixture comprising a coating agent and a solvent, wherein the coating agent comprises:
   one or more monoglycerides of a C₄-C₂₈ fatty acid; and
   one or more C₈-C₂₄ fatty alcohols,
   wherein a ratio of a total number of moles of the one or more monoglycerides to a total number of moles of the one or fatty alcohols is about 40:1 to about 1:1; and
removing at least a portion of the solvent to form a coating on the surface of the agricultural product.

Embodiment 58 is the method of embodiment 57, wherein the surface is a cuticular surface of the agricultural product.

Embodiment 59 is the method of embodiment 57 or embodiment 58, wherein contacting the surface comprises:
applying the mixture onto the surface; or
immersing the agricultural product in the mixture.

Embodiment 60 is the method of embodiment 59, wherein applying the mixture onto the surface comprises spraying or brushing the mixture onto the surface.

Embodiment 61 is the method of any one of embodiments 57-60, wherein removing at least a portion of the solvent comprises evaporating at least a portion of the solvent.

Embodiment 62 is the method of any one of embodiments 57-61, wherein the solvent comprises one or more of water, methanol, ethanol, isopropanol, butanol, acetone, ethyl acetate, chloroform, acetonitrile, tetrahydrofuran, diethyl ether, and methyl tert-butyl ether.

Embodiment 63 is the method of any one of embodiments 57-62, further comprising combining the coating agent with the solvent to yield the mixture.

Embodiment 64 is the method of any one of embodiments 57-63, further comprising combining the one or more C₈-C₂₄ fatty alcohols with a pre-mixture comprising the solvent and the one or more monoglycerides of a C₄-C₂₈ fatty acid to yield the mixture.

Embodiment 65 is the method of any one of embodiments 57-64, wherein a concentration of the coating agent in the mixture is about 1 mg/mL to about 200 mg/mL.

Embodiment 66 is the method of any one of embodiments 57-64, wherein a concentration of the coating agent in the mixture is about 25 mg/mL to about 150 mg/mL.

Embodiment 67 is the method of any one of embodiments 57-66, wherein one or more fatty alcohols are present in a total amount of about 5 wt % to about 40 wt % of the coating agent.

Embodiment 68 is the method of any one of embodiments 57-66, wherein one or more fatty alcohols are present in a total amount of about 10 wt % to about 35 wt % of the coating agent.

Embodiment 69 is the method of any one of embodiments 57-68, wherein the ratio of the total number of moles of the one or more monoglycerides to the total number of moles of the one or more fatty alcohols is about 30:1 to about 2:1.

Embodiment 70 is the method of any one of embodiments 57-69, wherein the ratio of the total number of moles of the one or more monoglycerides to the total number of moles of the one or more fatty alcohols is about 15:1 to about 2:1.

Embodiment 71 is the method of any one of embodiments 57-70, further comprising one or more salts of a C₄-C₂₈ fatty acid.

Embodiment 72 is the method of embodiment 71, wherein a ratio of a total number of moles of the one or more monoglycerides and the one or more fatty alcohols to a total number of moles of the one or more salts is about 100:1 to about 4:1.

Embodiment 73 is the method of embodiment 71 or embodiment 72, wherein a ratio of a total number of moles of the one or more monoglycerides and the one or more fatty alcohols to a total number of moles of the one or more salts is about 50:1 to about 6:1.

Embodiment 74 is the method of any one of embodiments 71-73, wherein the one or more monoglycerides, the one or more fatty alcohols, and the one or more salts make up at least 80 wt % of the composition.

Embodiment 75 is the method of any one of embodiments 57-74, wherein the one or more fatty alcohols each independently comprise a C₁₂-C₂₂ fatty alcohol.

Embodiment 76 is the method of any one of embodiments 57-74, wherein the one or more fatty alcohols each independently comprise a C₁₄-C₂₀ fatty alcohol.

Embodiment 77 is the method of any one of embodiments 57-74, wherein the one or more fatty alcohols each independently comprise a C₁₆ fatty alcohol, a C₁₈ fatty alcohol, or a combination thereof.

Embodiment 78 is the method of any one of embodiments 57-74, wherein at least one of the monoglycerides comprises a C₁₆-C₁₈ side chain and at least one of the fatty alcohols comprises a C₁₆-C₁₈ side chain.

Embodiment 79 is the method of any one of embodiments 57-78, wherein the side chain of at least one of the monoglycerides and the side chain of at least one of the fatty alcohols are the same.

Embodiment 80 is the method of embodiment 79, wherein the side chain is a C₁₆ side chain.

Embodiment 81 is the method of embodiment 79, wherein the side chain is a C₁₈ side chain.

Embodiment 82 is the method of embodiment 79, wherein the side chain is a C₂₂ side chain.

Embodiment 83 is a method of coating an agricultural product, the method comprising:
contacting a surface of the agricultural product with the mixture of any one of embodiments 45-52; and
removing at least a portion of the solvent to form a coating on the surface of the agricultural product.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composition comprising:
one or more monoglycerides of a C₄-C₂₈ fatty acid, present in a total amount of about 30 wt % to about 98 wt % of the composition; and
one or more C₈-C₂₄ fatty alcohols, present in a total amount of about 1 wt % to about 50 wt % of the composition.

2. The composition of claim 1, wherein the ratio of the total number of moles of the one or more monoglycerides to the total number of moles of the one or more fatty alcohols is about 30:1 to about 2:1.

3. The composition of claim 1, further comprising one or more salts of a C₄-C₂₈ fatty acid.

4. The composition of claim 3, wherein a ratio of a total number of moles of the one or more monoglycerides and the one or more fatty alcohols to a total number of moles of the one or more salts is about 100:1 to about 4:1.

5. The composition of claim 3, wherein the one or more monoglycerides, the one or more fatty alcohols, and the one or more salts are present in a total amount of at least about 80 wt % of the composition.

6. The composition of claim 1, wherein the one or more fatty alcohols each independently comprise a C₁₂-C₂₂ fatty alcohol.

7. The composition of claim 1, wherein a side chain of at least one of the monoglycerides and the side chain of at least one of the fatty alcohols are the same.

8. The composition of claim 1, wherein the composition comprises two or more monoglycerides, one of which is a monoglyceride of a C₈-C₁₄ fatty acid.

9. The composition of claim 8, wherein the monoglyceride of the C₈-C₁₄ fatty acid is present in a total amount of about 1 wt % to about 25% of the total amount of the two or more monoglycerides in the composition.

10. The composition of claim 1, wherein each of the one or more fatty alcohols independently comprises a compound of Formula III: 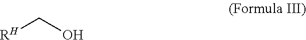
wherein R^{H} is a C₇-C₂₃ side chain.

11. The composition of claim 1, wherein each of the one or more fatty alcohols independently comprises a compound of Formula IIIA: 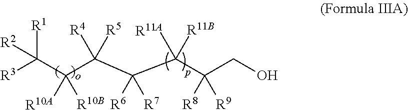
wherein:
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A} and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 15;
p is an integer from 0 to 15; and
the sum of o and p is from 3 to 15.

12. The composition of claim 1, wherein each of the one or more monoglycerides independently comprises a compound of Formula I-i or Formula I-ii: 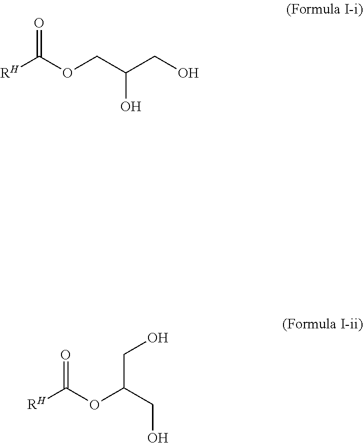
wherein R^{H} is a C₃-C₂₇ side chain.

13. The composition of claim 1, wherein each of the one or more monoglycerides independently comprises a compound of Formula IA-i or Formula IA-ii: 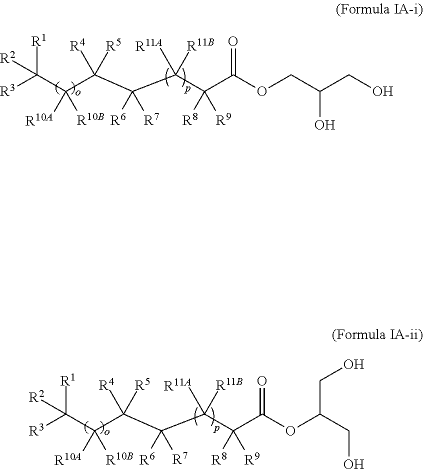
wherein:
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A} and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

14. The composition of claim 3, wherein each of the one or more salts present in the composition independently comprises a compound of Formula II: 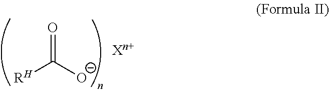
wherein:
each R^{H} is independently a C₃-C₂₇ side chain; and
Xⁿ⁺ is a cationic moiety having formal charge n.

15. The composition of claim 14, wherein:
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and
each occurrence of R^{D} is independently selected from H, C₁-C₆ alkyl, C₃-C₆ cycloalkyl, C₃-C₆ heterocycloalkyl, aryl, and heteroaryl, wherein:
each C₁-C₆ alkyl is optionally substituted with 1-3 R^{E} independently selected from C₃-C₆ cycloalkyl, C₃-C₆ heterocycloalkyl, aryl, and heteroaryl; and
optionally, one or more instances of R^{D} are taken together with the nitrogen atom to which they are attached to form a C₃-C₆ heterocycloalkyl.

16. The composition of claim 1, wherein each of the one or more salts present in the composition independently comprises a compound of Formula IIA: 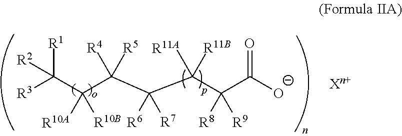
wherein:
each R¹, R², R³, R⁴, R⁵, R⁶, R⁷, R⁸, and R⁹ are independently selected from H, OH, C₁-C₆ alkyl, C₂-C₆ alkenyl, and C₁-C₆ alkoxy;
each occurrence of R^{10A}, R^{10B}, R^{11A} and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17;
the sum of o and p is from 0 to 17; and
Xⁿ⁺ is a cationic moiety having formal charge n.

17. A mixture comprising:
one or more monoglycerides of a C₄-C₂₈ fatty acid, present in a total amount of about 30 wt % to about 98 wt % of the mixture, and one or more C₈-C₂₄ fatty alcohols, present in a total amount of about 1 wt % to about 50 wt % of the mixture; or
one or more monoglycerides of a C₄-C₂₈ fatty acid and one or more C₈-C₂₄ fatty alcohols, wherein a ratio of a total number of moles of the one or more monoglycerides to a total number of moles of the one or more fatty alcohols is about 40:1 to about 1:1; and
a solvent.

18. A method of coating an agricultural product, the method comprising
contacting a surface of the agricultural product with a mixture comprising a coating agent and a solvent, wherein the coating agent comprises:
one or more monoglycerides of a C₄-C₂₈ fatty acid; and
one or more C₈-C₂₄ fatty alcohols;
wherein a ratio of a total number of moles of the one or more monoglycerides to a total number of moles of the one or fatty alcohols is about 40:1 to about 1:1; and
removing at least a portion of the solvent to form a coating on the surface of the agricultural product.

19. The method of claim 18, wherein a concentration of the coating agent in the mixture is about 1 mg/mL to about 200 mg/mL.

20. The method of claim 18, wherein one or more fatty alcohols are present in a total amount of about 5 wt % to about 40 wt % of the coating agent.
